(19) United States
(12) Patent Application Publication
(10) Pub. No.: US 2026/0243360 A1
(43) Pub. Date: Aug. 20, 2026

(54) ELECTROFLUIDIC TRANSDUCER

(71) Applicant: Worcester Polytechnic Institute, Worcester, MA (US)

(72) Inventors: Ritwik Pandey, Worcester, MA (US); Pratap Rao, Northborough, MA (US); Markus P. Nemitz, Southborough, MA (US)

(21) Appl. No.: 19/426,477

(22) Filed: Dec. 19, 2025

Related U.S. Application Data
(60) Provisional application No. 63/736,157, filed on Dec. 19, 2024.
(60) Provisional application No. 63/742,058, filed on Jan. 6, 2025.

(51) Int. Cl. F16K 17/40; B33Y 80/00

(52) U.S. Cl. CPC F16K 13/04; B33Y 80/00

(57) ABSTRACT

A flexible transducer is responsive to an electrical circuit for rupturing or perforating a substrate material with a printed trace defining a circuit element. The substrate defines a fluidic seal or valve on a vessel for controlling fluidic communication with the vessel. The control circuit delivers an electrical flow across the trace for inducing an arc or current flow sufficient to melt the substrate and allow the fluid to pass through a formed perforation. Flexible construction of the substrate and vessel are amenable to usage in soft-bodied robots. A flexible polymer such as TPU (Thermoplastic Polyurethane) may receive a printed conductive ink in thermal communication with the substrate from a current flow or voltage arc along the substrate. Controlled passage of a gas through the perforation provides a valve or fluid release in a deformable robotic configuration.

### RELATED APPLICATIONS

This patent application claims the benefit under 35 U.S.C. § 119(e) of U.S. Provisional Patent App. No. 63/736,157, filed Dec. 19, 2024, entitled “ELECTROFLUIDIC TRANSDUCER,” and of U.S. Provisional Patent App. No. 63/742,058, filed Jan. 6, 2025, entitled “ELECTROFLUIDIC TRANSDUCER VALVE,” both incorporated herein by reference in entirety.

### BACKGROUND

Additive manufacturing has evolved from the use of 3-Dimensional (3D) printers and related technology for efficient, low cost use in tasks that traditionally required large machined molds or dies to produce. Efficient manufacturing is achievable for modest volumes of printed articles without the upfront investment in a large, expensive die. Suitable printed mediums include conductive materials, allowing electric and insulative materials to be printed for electronic components and circuit boards.

### SUMMARY

A flexible transducer is responsive to an electrical circuit for rupturing or perforating a substrate membrane material with a printed trace defining a circuit element. The substrate defines a fluidic seal or valve on a vessel for controlling fluidic communication with the vessel. The control circuit delivers an electrical flow across the trace for inducing an arc or current flow sufficient to melt the substrate and allow the fluid to pass through a formed perforation. Flexible construction of the substrate and vessel are amenable to usage in soft-bodied robots. A flexible polymer such as TPU (Thermoplastic Polyurethane) may receive a printed conductive ink in thermal communication with the substrate from a current flow or voltage arc along the substrate. Controlled passage of a gas through the perforation provides a valve or fluid release in a deformable robotic configuration.

Configurations herein are based, in part, on the observation that fluidic controls are often employed in robotic configurations for pneumatic activation or similar pressurized delivery for actuated movement. Unfortunately, conventional approaches to fluidic management suffers from the shortcoming that dense and/or bulky components such as solenoids, coils, piston or cylindrical actuators and the like are difficult to implement in soft or deformable robotic configurations. Accordingly, configurations herein substantially overcome the problems of conventional fluid management in soft robots by providing a soft transducer or valve responsive to an electrical signal for controlling fluid release from a deformable vessel without dense metallic components such as coils and cylinders.

In further detail, a nonrigid transducer device for fluidic control includes a flexible, nonconductive substrate impermeable to a controlled fluid, and a flexible, conductive trace deposited on the substrate. A concave structure sealingly engaged with the substrate forms a vessel for enclosing the conductive trace in or on an encapsulating void, and a control circuit connected to the conductive trace is configured for delivering a disrupting signal to breach the substrate for liberating the encapsulated void.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context view of the disclosed approach for soft robotic fluidic control as disclosed herein;

FIGS. 2A and 2B show the traces of FIG. 1 in both a current and voltage (spark gap) configuration;

FIGS. 3A-3D show printed/valve structures including the traces of FIGS. 2A-2B;

FIG. 4 shows an example of a control circuit powering the traces of FIGS. 1-3D;

FIG. 5 shows a chart of pressure values maintained in the vessel of FIGS. 1-3D pending solenoid/valve release;

FIG. 6 shows a graph of the pressure values of FIG. 5; and

FIG. 7 shows a print rendering of the concave vessel of FIGS. 3A-3D.

### DETAILED DESCRIPTION

An additively formed, deformable printed single use electrofluidic switch or valve that relies on a high current or voltage pulse to heat a printed conductive trace that melts a membrane that blocks the flow of a gas. The geometry of the conductive trace creates localized high resistance regions allowing for control over melt zones that form a controlled perforation for fluidic release.

With the increase in popularity of soft robots, pneumatic methods of powering them have gained favor. Electronic switching of pneumatic flows has been a notable shortcoming in these systems. Existing conventional solutions are bulky, expensive, power inefficient, intolerant of high pressures, and generally require specialized manufacturing equipment. In contrast, the disclosed approach comprises soft, deformable construction such that all the parts measure 75A or below on the Shore-A hardness scale, can be scaled down to the micro level, and consume very little power.

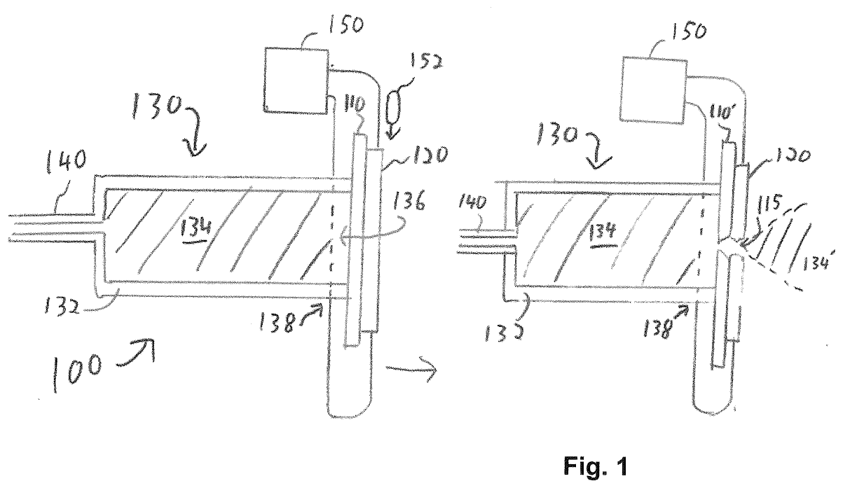

FIG. 1 is a context view of the disclosed approach for soft robotic fluidic control as disclosed herein. Referring to FIG. 1, a nonrigid transducer device 100 for fluidic control includes a flexible, nonconductive substrate 110 impermeable to a controlled fluid, and a flexible, conductive trace 120 deposited, printed or adhered on the substrate 110. The substrate 110 typically forms a vessel 130 with the substrate, such that the substrate defines a wall or portion of the vessel 130 and a complementary structure 132 forms a sealed volume 134 from a concave recession 136 and sealing engagement 138 with the substrate 110, thus forming a sealed, pressurized fluidic volume for encapsulating fluidic contents of a flammable or nonflammable gas or liquid.

A fluidic input 140 may be sealingly engaged with the vessel for providing a fluidic source. A control circuit 150 connects to the conductive trace 120 for generating a disrupting signal 152 in response to a suitable operator, robotic or other input to release the fluidic contents of the sealed volume 134. The control circuit 150 is configured for delivering the disrupting signal 152 across the trace 120 to perforate the substrate 110′ for fluidic communication 134′ through the breached substrate 110′, releasing the encapsulated fluid.

The disrupting signal 152 is defined by an electrical signal from the control circuit 150, such that the electrical signal generates heat for melting the substrate to form the perforation 115. The formed perforation 115 of the substrate 110′ liberates the fluid contents of the vessel 130, based on the pressure accumulated in the vessel 130. Both the substrate 110 and the complementary structure 132 are formed from flexible (“soft”) deformable materials, and at least the substrate 110 is responsive to heat for melting or rupturing in response to heat generated by the disruption signal 152, typically a polymer. The conductive trace 120 may also be flexible, and is generally in planar alignment with the substrate 110, while the complementary structure 132 may be any suitable shape such as tubular, conical or other suitable form defining the concave recession 136 to form the fluid containing sealed volume 134 responsive to liberation by the control circuit 150.

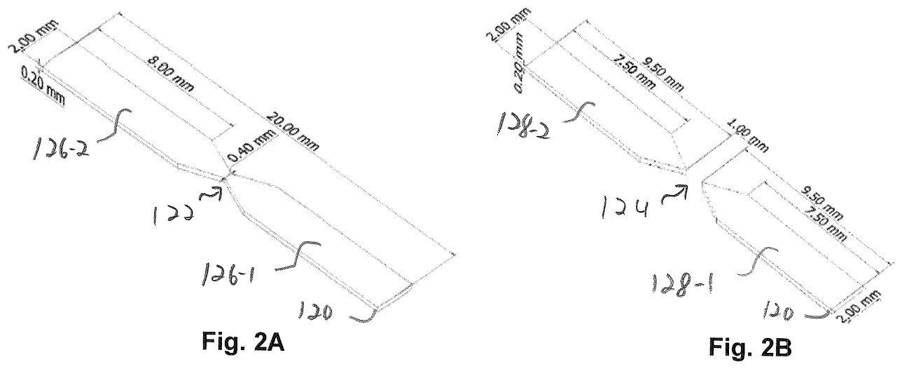

FIGS. 2A and 2B show the traces of FIG. 1 in both a current and voltage (spark gap) configuration. The layered substrate 110 and current trace 120 form a region where a controlled electrical disruption signal 152 across the trace 120 melts or burns the immediately adjacent or contacting substrate 110. As the substrate forms the continuous volume with the complementary structure, any breach allows a passage for fluidic transfer. The electrical disruption signal 152 may generate heat from a high current flow (FIG. 2A) or a spark arcing across a gap (FIG. 2B).

Referring to FIGS. 1 and 2A, the trace 120 has a portion 122 of reduced cross section, such that the reduced cross section is responsive to the electrical current of the disrupting signal 152, where the electrical resistance of the portion 122 results in the current heating the reduced cross section 122 to melt the substrate 110. Trace elements 126-1 and 126-2 are electrically continuous until broken by melting the reduced cross section portion, similar to an electrical fuse.

Referring to FIGS. 1 and 2B, the trace 120 has a discontinuity 124 and the disrupting signal 152 has sufficient voltage to induce an arc across a spark gap defined by the discontinuity 124, such that the arc generates heat for melting the substrate 110. In the spark gap configuration, trace elements 128-1 and 128-2 are discontinuous both before and after receiving the disruption signal 152, and the heat of the arc melts or burns the substrate 110. The voltage and current based control differs in power and timing requirements to form the perforation 115.

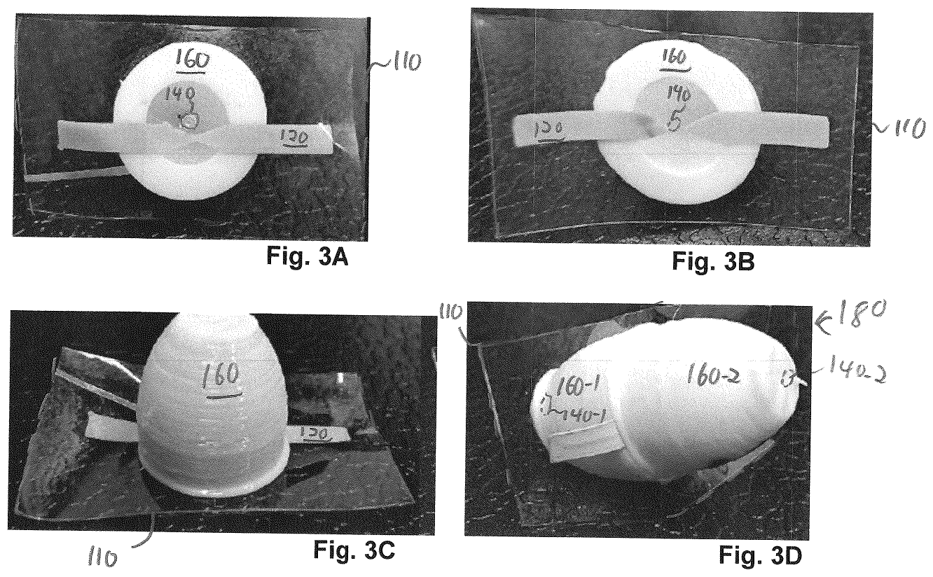

FIGS. 3A-3D show printed valve structures including the traces 120 of FIGS. 2A-2B printed on the substrate 110. The formation of the perforation 115 to release the encapsulated volume 134 of gas effectively operates as a valve which provides pneumatic control in a robotic system. Alternatively, it operates as a transducer by transferring energy between electrical and mechanical forms to control the breach at perforation 115.

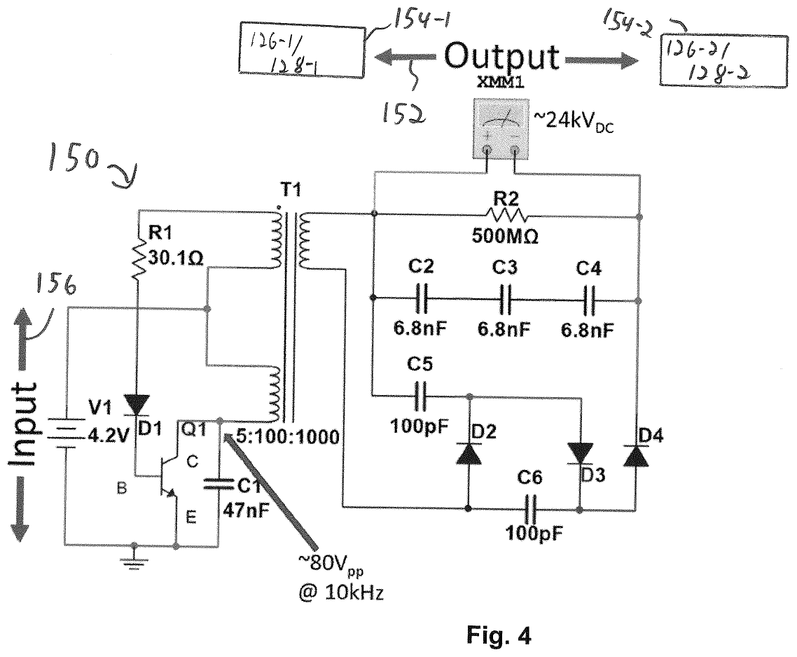

The electric current-controlled electrofluidic transducer device 100 therefore includes three parts: a substrate 110 membrane that blocks the flow of the fluid (gas), a conductive trace 120 that is printed onto the membrane that melts and perforates the membrane, and tube connectors 140 including concave structures 160 formed on either side of the membrane to connect input and output fluid travel lines or tubes. In FIGS. 4A and 4B, the disclosed method for controlling fluidic flow includes forming the conductive trace 120 on a non-conductive substrate 110, followed by connection of a control circuit 150 as in FIGS. 1 and 4 to opposed elements 126/128 of the trace.

A vessel 130 is formed having a fluidic volume 134 in a sealed engagement with the substrate 110, and a tube, hose, needle or other fluidic input 140 populates the vessel with a fluid, typically a pressurized gas. The vessel may be formed by any suitable approach, such as additive manufacturing or printing of a soft, deformable media, externally cast and adhered to the substrate, or other suitable mechanism. Once the pressurized fluid is injected into the vessel, controlled release of the pressurized fluid occurs via the perforation 115 upon receipt of a disrupting signal 152.

Referring to FIG. 3C, the concave structures 160 form the vessel 130 as a frustoconical or slightly curved conical shape, however any suitable shape defining a concave recession may be employed to form the vessel 130 including the substrate 110, such that the vessel 130 is configured for containing a fluid releasable upon formation of the perforation. In FIG. 3C, a concave structure 160 is formed on the substrate, such that the vessel 130 is defined by the concave structure 160 (160-1) and the substrate 110. In other words, any vessel shape incorporating the substrate 110 as a wall or exterior, encapsulating portion of the sealed volume 134 may be employed. In an example configuration, the vessel 130 and the substrate 110 are formed from deformable materials for lightweight and flexible integration into a soft body robotic context.

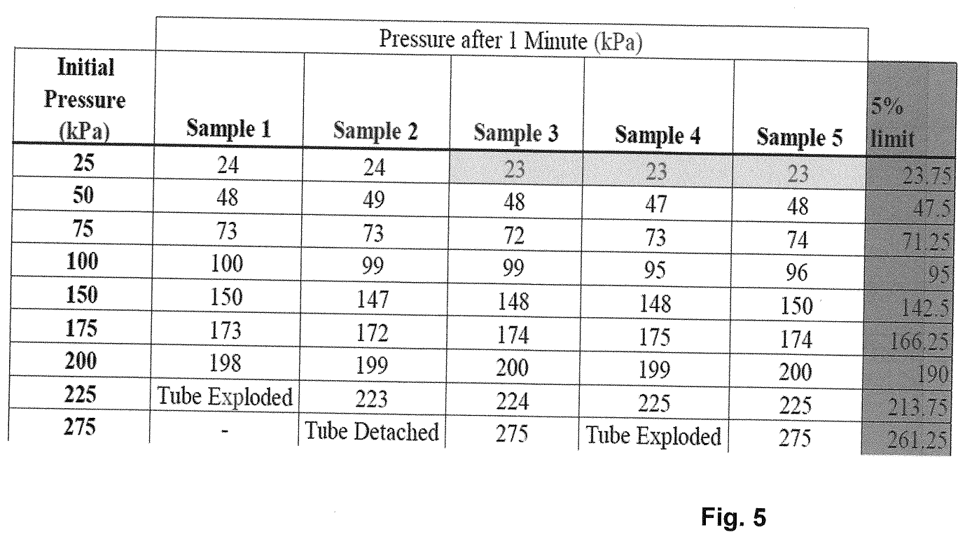

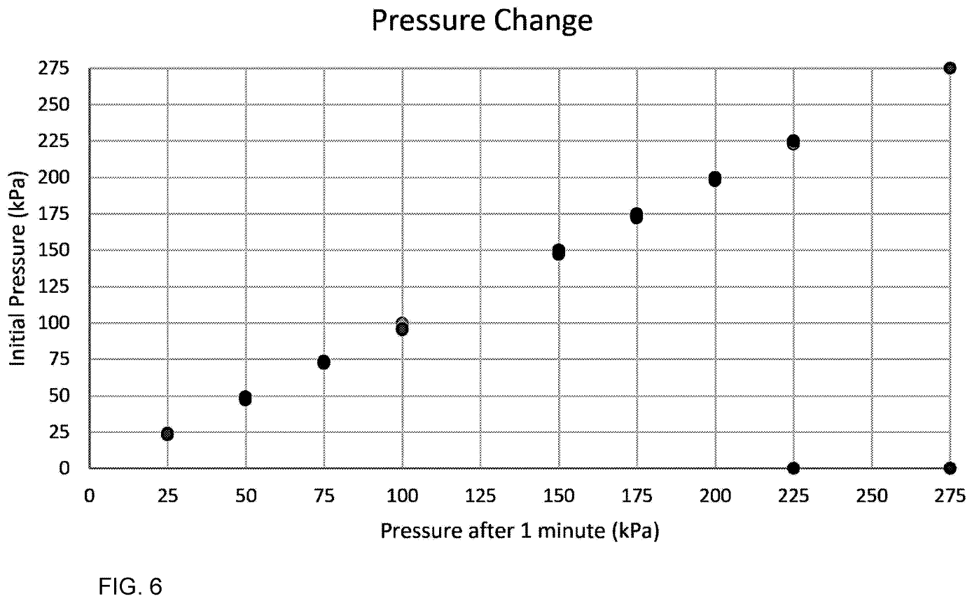

FIG. 3D shows a completed solenoid or valve system, where a second concave structure 160-2 (160 generally) forms an output from the open perforation 115. Fluidic inputs and outputs 140-1 . . . 140-2 respectively (140 generally) may be sealingly engaged with the concave structures 160 to form a sealed volume. In a particular configuration, flexible tubes such as PVC (polyvinyl chloride) or nylon may be frictionally inserted into apertures sufficiently tight to withstand the vessel pressure, shown further below in FIGS. 5 and 6.

FIG. 4 shows an example of a control circuit 150 powering the traces of FIGS. 1-3D. Any suitable voltage or current signal may be employed for generating the disruption signal 152. In general, the current flow version relies on a sufficiently high current flow that electrical resistance heat at the reduced cross section portion 122 sufficient to melt the substrate 110 and form the perforation. Similarly, the spark gap configuration relies on sufficient voltage to generate the spark.

In a general configuration, the control circuit 150 connects outputs 154-1 . . . 154-2 (154 generally) to opposed ends of the trace 120, such that the control circuit 150 is configured to complete an electrical circuit across the trace upon an input switch or source 156. The trace 120 is responsive to the circuit 150 for generating heat above a melting point of the substrate 110. The current flow or voltage arc then heats the substrate 110 from thermal communication with the trace 120, as the substrate 110 is responsive to melt and form the perforation 115 responsive to the heat.

To trigger the trace 120 and form the perforation 115 in the current flow configuration of FIG. 2A, an electrical signal (from a microcontroller or equivalent) is used to turn on an N-channel MOSFET (to allow a flow from drain to source). A lithium polymer battery that is capable of supplying ~2.5 A at ~0.5V is connected to the drain of the MOSFET and a connection tab of the fuse is attached to the source of the MOSFET.

In an example configuration of the spark gap trace of FIG. 2B, a voltage amplifying circuit 150 such as in FIG. 4 may be employed. The input could be connected to the source of the MOSFET and the output could be connected to the spark gap trace 120. This circuit consists of an oscillator on the primary side of a step-up transformer and a voltage tripler on the secondary side.

For construction of the device of FIGS. 3A-3D, the substrate 110 membrane could either be printed via fused deposition modelling (FDM) and a low shore hardness thermoplastic polyurethane (TPU) or be made from a sheet of pre-cast TPU. One configuration employs a sheet of Lubrizol Estane FSL75A4P with a shore hardness of 75A and a thickness of 0.09 mm. In an example configuration, the substrate 110 may be printed with settings according to Table I.

TABLE I

| Printer | Prusa i3 MK3S+ or Prusa MK4 |
|---|---|
| Filament | FilaFlex Thermoplastic Polyurethane |
| Filament Diameter (mm) | 1.75 |
| Filament Hardness | 60A |
| Nozzle Diameter (mm) | 0.4 |
| Bed Temperature (° C.) | 70 |
| Extruder Temperature (° C.) | First Layer: 240; Rest: 235 |
| Fill Pattern | Concentric |
| Layer Thickness (mm) | 0.1 |
| Number of Layers | 2 |
| Extrusion Multiplier | 1.2 |

The trace 120 may be printed onto the substrate 110 either using FDM (Fused Deposition Modeling) printing or Direct Ink Write (DIW), or other suitable approach for layering a conductive trace. The DIW version was printed on a printer such as Voltera Nova with the following settings shown in Table II:

TABLE II

| Ink | ACI Materials SE1109 Stretchable Silver |
|---|---|
| Nozzle Diameter (μm) | 225 |
| Ink Temperature | 35° C. |
| Print speed (mm/min) | 600 |
| Trace Spacing (μm) | 220 |
| Print Height (μm) | 140 |
| Dispense Pressure | 1000 |
| Relief Pressure | 600 |
| Number of Layers | 2 |

The FDM printed version used the following settings in Table III:

TABLE III

| Printer | Prusa i3 MK3S+ or Prusa MK4 |
|---|---|
| Filament | Multi3D Electrifi |
| Filament Diameter (mm) | 1.75 |
| Nozzle Diameter (mm) | 0.4 |
| Bed Temperature | No heat |
| Extruder Temperature (° C.) | 145 |
| Print Speed (mm/s) | 10 |
| Fill Pattern | Concentric |
| Layer Thickness (mm) | 0.1 |
| Number of Layers | 2 |

This operation generates the traces 120 with the dimensions of FIGS. 2A and 2B for the respective current flow and spark gap configurations.

For the DIW printed version of the trace 120, it may be noted that the second layer is printed by increasing the print height to 220 μm. The ink is cured at 140° C. for 15 minutes in a convection oven; omission of this step will result in poor adhesion to the membrane and very poor electrical properties (high resistance).

The concave structures 160 including any tube connectors 140 for input and output may be formed according to the parameters of Table IV:

TABLE IV

| | |
|---|---|
| Printer | Prusa i3 MK3S+ or Prusa MK4 |
| Filament | FilaFlex Thermoplastic Polyurethane |
| Filament Diameter (mm) | 1.75 |
| Filament Hardness | 60A |
| Nozzle Diameter (mm) | 0.4 |
| Bed Temperature (° C.) | 70 |
| Extruder Temperature (° C.) | First Layer: 240; Rest: 235 |
| Fill Pattern | Concentric |
| Layer Thickness (mm) | 0.1 |
| Number of Layers | 2 |
| Extrusion Multiplier | 1.2 |
| Z-Offset | 0 |
| Other Important settings | Prevent crossing of perimeters |
| | Disable Elephant foot compensation |

To form the vessel 130, the substrate with the printed trace is placed on the print bed and the concave structure 160 is centered on the trace 120 and substrate 110.

Pressure withstanding tests were conducted to determine the maximum pressure that the valve could withstand without leaking. Tubes were connected to either end of the valve an air supply with a pressure gauge was attached to one end and a tube venting to the atmosphere was connected to the other end. The pressure was increased in increments of 25 kPa and held for a minute by manually closing a valve to the supply. The pressure after a minute was recorded and compared to the original value. The electrofluidic transducer and venting tube were submerged in water throughout test to test for visual indicators of leaks. Results from the pressure withstanding tests are as shown in FIGS. 5 and 6.

FIG. 5 shows a chart of pressure values maintained in the vessel of FIGS. 1-3D pending solenoid/valve release, and FIG. 6 shows a graph of the pressure values of FIG. 5. The electrofluidic transducers, meaning the vessel defined by the membrane 110 and concave structure 160, did not fail during any of the tests, but rather connections to them started failing at pressures over 200 kPa by pulling out of the fluidic input holes of 140. This resilient, frictional fitting may be better served by an adhesive, glue, caulk and/or fusion welding approach.

Still further, tests were conducted to measure the time taken for the high voltage arc to perforate the substrate 110 (FIG. 2B) by recording the spark gap being triggered with a high-speed camera. The average time to first arc was 20.83 ms and the average trigger impulse to perforation time was 202.08 ms. Conversely, the time taken for the fuse/current approach (FIG. 2A) to perforate the membrane resulted in an average trigger impulse to perforation time was 1107.92 ms.

In other trials, current and voltage between the configurations of FIGS. 2A-2B experienced the following:
Current controlled version: ~1.25 W (2.5 A at 0.5V)
Voltage controlled version: ~0.4 W (50 μA at ~8 kV)

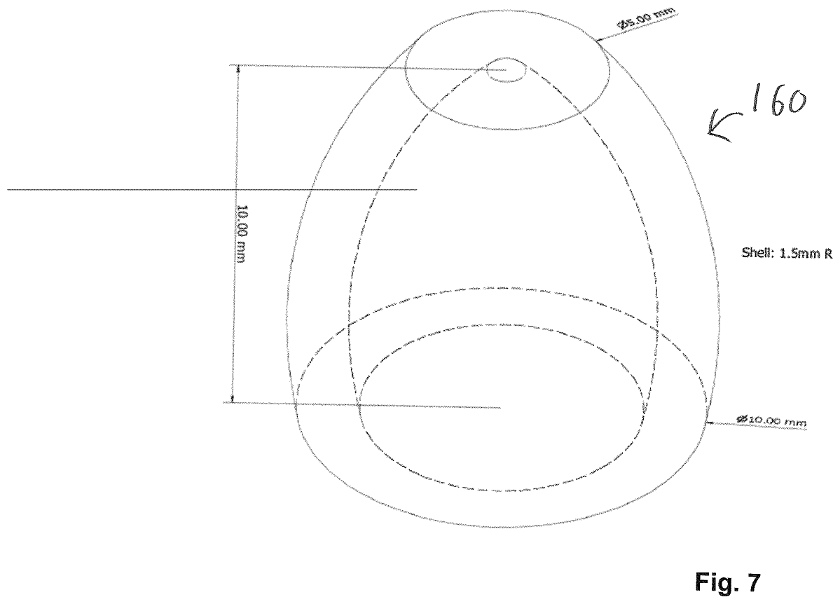

FIG. 7 shows a print rendering of the concave vessel 160 of FIGS. 3A-3D. In a particular example configuration, formation of the concave structure 160 is as follows. The bottom outer diameter is 10 mm, the height is 10 mm, the shell thickness is 1.5 mm, and the radius of the top hole is 1 mm with a 5 mm outer diameter. Printing directly on the substrate and fuse creates an airtight seal with the top hole of the tube connector 140 being the only opening. The concave structure 160-2 and tube connection 140-2 on the other side of the substrate was printed separately and attached. The bottom surface of the concave structure 160-2 was heated with a hot-air gun set to 200° C. for about 30 seconds until the surface showed visible signs of melting and then pressed onto the other side of the membrane keeping the structure 160-2 centered over the cross section/gap 122/124.

A modest pressure drop may be experienced depending on the manner of engaging a gaseous supply to the tube connection 140. Any suitable fluidic attachment may be performed to engage the input and output tube connectors 140-1 . . . 140-2 to a pressurized or pneumatic system. Methods of attachment/engagement in a fluidic system may include:
Invert the concave structure 160 and place it on a jig. Print the second tube connector 140-2 using the FDM printer;
Employ a hot-air gun to heat and melt the second tube connector 140-2 and press it onto the membrane;
Chemical and/or solvent adhesion such as Dimethyl Sulfoxide (DMSO) to chemically melt a few layers of the second tube connector and press it on. The connection 140 could also be sealed using curable materials such as vulcanizing silicone.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A nonrigid transducer device for fluidic control, comprising:
a flexible, nonconductive substrate impermeable to a controlled fluid;
a flexible, conductive trace deposited on the substrate;
a control circuit connected to the conductive trace, the control circuit configured for delivering a disrupting signal to perforate the substrate for fluidic communication through the substrate.

2. The device of claim 1 further comprising a vessel formed with the substrate, the perforation of the substrate liberating a fluid contents of the vessel.

3. The device of claim 1 wherein the disrupting signal is defined by an electrical signal from the control circuit, the electrical signal melting the substrate to form the perforation.

4. The device of claim 1 wherein the trace has a discontinuity and the disrupting signal induces an arc across a gap defined by the discontinuity, the arc generating heat for melting the substrate.

5. The device of claim 1 wherein the trace has a portion of reduced cross section, the reduced cross section responsive to a current of the disrupting signal, the current heating the reduced cross section to melt the substrate.

6. The device of claim 3 wherein the control circuit connects to opposed ends of the trace, the control circuit configured to complete an electrical circuit across the trace, the trace responsive to the circuit for generating heat above a melting point of the substrate.

7. The device of claim 1 further comprising a vessel formed including the substrate, the vessel configured for containing a fluid releasable upon formation of the perforation.

8. The device of claim 7 further comprising a concave structure formed on the substrate, the vessel defined by the concave structure and the substrate.

9. The device of claim 7 wherein the vessel and the substrate are formed from deformable materials.

10. The device of claim 1 wherein the traces are formed from DIW (Direct Ink Write) or FDM (Fused Deposition Modeling) onto a surface of the substrate.

11. The device of claim 1 further comprising a fluid input on the vessel, the fluid input configured to receive the fluid to form a pressurized fluid volume in the vessel, the perforation defining a release of the pressurized fluid.

12. A method for controlling fluidic flow, comprising:
forming a conductive trace on a non-conductive substrate;
connecting a control circuit to the trace; and
applying an electrical source across the trace, the electrical source configured for providing a controlled electrical flow for perforating the substrate.

13. The method of claim 12 further comprising heating the substrate from thermal communication with the trace, the substrate responsive to melt and form the perforation responsive to the heat.

14. The method of claim 12 further comprising:
forming a vessel having a fluidic volume in a sealed engagement with the substrate;
injecting a pressurized fluid into the vessel; and
releasing the pressurized fluid via the perforation upon receipt of a disrupting signal.

15. The method of claim 13 wherein the disrupting signal is an electrical signal, further comprising melting the substrate to form the perforation.

16. The method of claim 12 wherein the trace is formed from DIW (Direct Ink Write) or FDM (Fused Deposition Modeling) onto the substrate.
